(19) United States
(12) Patent Application Publication
(10) Pub. No.: US 2024/0220858 A1
(43) Pub. Date: Jul. 4, 2024

(54) MACHINE LEARNING AUTOMATED SIGNAL DISCOVERY FOR FORECASTING TIME SERIES

(71) Applicant: International Business Machines Corporation, Armonk, NY (US)

(72) Inventors: Xuan-Hong DANG, Chappaqua, NY (US); Petros ZERFOS, New York, NY (US); Syed Yousaf SHAH, Yorktown Heights, NY (US); Anil R. SHANKAR, New York, NY (US)

(21) Appl. No.: 18/315,487

(22) Filed: May 10, 2023

(30) Foreign Application Priority Data
Dec. 29, 2022 (GR) 20220101087

(51) Int. Cl. G06N 20/00

(52) U.S. Cl. CPC G06N 20/00

(57) ABSTRACT

A prediction system may obtain data, via a network, from devices and process the data, using a first machine learning, to identify a plurality of signals. The prediction system may train a second machine learning model to analyze the plurality of signals to forecast a first forecasted time series and evaluate a first performance of the first forecasted time series. The prediction system may determine that the first performance does not satisfy a performance threshold and may refine the plurality of signals to obtain a refined plurality of signals. The prediction system may train a third machine learning model to analyze the refined plurality of signals to forecast a second forecasted time series and evaluate a second performance of the second forecasted time series. The prediction system may use the refined plurality of signals and the third machine learning model to predict a performance of a third forecasted time series.

### RELATED APPLICATION

This application claims priority to Greek Patent Application No. 20220101087, entitled “MACHINE LEARNING AUTOMATED SIGNAL DISCOVERY FOR FORECASTING TIME SERIES,” filed Dec. 29, 2022, which is incorporated herein by reference in its entirety.

### BACKGROUND

The present invention relates to the field of artificial intelligence, and more specifically, to machine learning models that automatically discover signals used for forecasting time series. A time series refers to a series of data points that are provided in a chronological order.

### SUMMARY

In some implementations, a computer-implemented method comprises forecasting a first forecasted time series using a first machine learning model. The first machine learning model forecasts the first forecasted time series using a plurality of signals. The computer-implemented method further comprises refining the plurality of signals to obtain a refined plurality of signals based on evaluating a first performance of the first forecasted time series. The plurality of signals are refined based on determining that the first performance does not satisfy a performance threshold. The computer-implemented method further comprises forecasting a second forecasted time series using a second machine learning model. The second machine learning model forecasts the second forecasted time series using the refined plurality of signals. The computer-implemented method further comprises determining that a second performance, of the second forecasted time series, satisfies the performance threshold; and using the refined plurality of signals and the second machine learning model to predict a third forecasted time series based on determining that the second performance satisfies the performance threshold.

In some implementations, a computer program product comprises one or more computer readable storage media, and program instructions collectively stored on the one or more computer readable storage media. The program instructions comprise program instructions to forecast a first forecasted time series using a first forecasting model. The first forecasting model is trained using first sentiment scores associated with a plurality of topics. The program instructions further comprise program instructions to determine that a first performance, of the first forecasted time series, does not satisfy a performance threshold; and program instructions to refine the plurality of topics to obtain a refined plurality of topics. The plurality of topics are refined based on determining that the first performance does not satisfy the performance threshold. The program instructions further comprise program instructions to forecast a second forecasted time series using a second forecasting model. The second forecasting model is trained using second sentiment scores associated with the refined plurality of topics. The program instructions further comprise program instructions to use the refined plurality of topics and the second forecasting model to forecast a third forecasted time series based on a second performance of the second forecasted time series satisfying the performance threshold.

In some implementations, a system comprises one or more devices configured to forecast a first forecasted time series using a first forecasting model. The first forecasting model is trained using first sentiment scores associated with a plurality of topics. The one or more devices are further configured to determine that a first performance, of the first forecasted time series, does not satisfy a performance threshold; and refine the plurality of topics to obtain a refined plurality of topics. The plurality of topics are refined based on determining that the first performance does not satisfy the performance threshold. The one or more devices are further configured to forecast a second forecasted time series using a second forecasting model. The second forecasting model is trained using second sentiment scores associated with the refined plurality of topics. The one or more devices are further configured to determine that a second performance of the second forecasted time series satisfies the performance threshold; and use the refined plurality of topics and the second forecasting model to forecast a third forecasted time series based on determining that the second performance satisfies the performance threshold.

### BRIEF DESCRIPTION OF THE DRAWINGS

FIGS. 1A-1H are diagrams of an example implementation described herein.

FIG. 2 is a diagram of an example environment in which systems and/or methods described herein may be implemented.

FIG. 3 is a diagram of an example computing environment in which systems and/or methods described herein may be implemented.

FIG. 4 is a diagram of example components of one or more devices of FIGS. 2 and 3.

FIG. 5 is a flowchart of an example process relating to forecasting time series and/or predicting a performance of forecasted time series.

### DETAILED DESCRIPTION

The following detailed description of example implementations refers to the accompanying drawings. The same reference numbers in different drawings may identify the same or similar elements.

In some examples, a text corpus may include information that may be used to forecast a time series (e.g., predict data points over a period of time). The time series may be forecasted (e.g., by one or more computing devices) based on topics identified by the information. Identifying topics that may be used to forecast a time series is subject to several challenges.

One challenge relates to manually selecting the topics from the text corpus. Manually selecting the topics is subject to potential loss of important information (included in the text corpus) that may be used to predict the time series in an accurate and a complete manner. In other words, the topics that are manually selected may be inaccurate and incomplete, thereby leading to inaccuracies and incompleteness of the time series. The inaccuracies and incompleteness of the time series may cause a computing device, that uses the time series, to operate in an undesired manner. Additionally, manually selecting the topics from the text corpus is a time consuming process, requiring domain expertise.

Furthermore, selecting a proper set of topics using a computing system (e.g., one or more computing devices) presents a technical challenge for multiple reasons. One reason is that the degree of importance of each topic may vary from time to time while a set of overall topics may need revisions if the ability to forecast a time series deteriorates. Another reason is that language, included in the text corpus, is vague and insufficiently descriptive.

Yet another reason is the high dimensionality and sparsity of text data included in the text corpus. “High dimensionality” of text data refers to the data dimensionality of numerical vectors that represent for words, sentences, documents appeared in the text corpus. Sparsity of text data refers to the lack of occurrence of the text data in a particular quantity of documents. In this regard, high dimensionality and sparsity of text data complicate the process of identifying useful topics and of forecasting signals for time series. Still another reason is that identifying a proper set of topics requires combining multiple documents, from different time periods, at different weights. Additionally, selecting a proper set of topics in this manner is time consuming.

Another technical challenge relates to a difference, with respect to modality, between the topics obtained from the text corpus and the time series to be forecasted. For example, the topics (e.g., obtained from the text corpus) are discrete and categorical while signals (or data) of the time series signals are continuous and numerical. Accordingly, using a computing system to forecast numerical and continuous signals of a time series from discrete and categorical textual topics presents a technical challenge. For example, the technical challenge may be based on the ability to determine a correlation between the numerical and continuous signals of a time series and the discrete and categorical textual topics. Additionally, using the computing system in this manner is a time consuming process.

The inability to overcome the above challenges may subject forecasted time series to inaccuracies. The time series may be used by computing systems to perform operations. In this regard, inaccuracies in forecasting time series and/or in forecasting behaviors in time series cause the computing systems to malfunction. Such inaccuracies in forecasting time series may waste computing resources, network resources, and other resources that are used to identify the inaccuracies, to remedy the inaccuracies, and to re-configure the computing systems to enable the computing systems to perform properly. Accordingly, there is a need to more accurately and efficiently identify topics (e.g., from a text corpus) and to more accurately and efficiently forecast a time series.

Embodiments of the present invention provide solutions to improve/eliminate the inaccuracies discussed above. For example, implementations described herein achieve this improvement by automatically identifying signals that may be used to forecast a time series and/or used to predict a performance of a forecasted time series. Forecasting a time series may refer to predicting data points that occur chronologically over a period of time.

In some examples, a prediction system may obtain data via a network. For instance, the prediction system may obtain the data as a result of web crawling and/or web scraping. The data may be a text corpus. The prediction system may process the data to discover the topics. The data may be a text corpus that includes documents. In some instances, when processing the data, the prediction system may split up the documents to disaggregate the documents into sentences and/or paragraphs.

The prediction system may perform automated hierarchical topic modeling on the sentences and/or paragraphs to discover topics and/or identify a hierarchy of topics. In some examples, when discovering the topics, the prediction system may use a machine learning model that implements a natural language processing algorithm. The prediction system may refine the topics and/or the hierarchy of topics to obtained refined topics. In some situations, when refining the topics and/or the hierarchy of topics, the prediction system may evaluate measures of quality of the topics and/or of the hierarchy of topics. As a result of refining the topics and/or the hierarchy of topics, the prediction system may prune or remove less relevant topics and/or remove minor topics. The prediction system may assign the sentences discussed above to the refined topics.

The prediction system may automate generating sentiment scores associated with the refined topics. For example, the prediction system may generate sentiment scores for the sentences of the refined topics. A sentiment score, for a sentence, may indicate a sentiment associated with the sentence. The sentiment may be a positive sentiment, a neutral sentiment, or a negative sentiment. In some situations, the sentiment scores may range from a value of −1 to a value of 1. For example, the sentiment score for a negative sentiment may be a negative sentiment score (e.g., a negative value such as −0.7). A sentiment score for a positive sentiment may be a positive sentiment score (e.g., a positive value such as 0.7). A sentiment score for a neutral sentiment may range from a value of −0.25 to a value of 0.25. The prediction system may generate the sentiment scores using one or more lexicons and/or one or more valence shifters. A valence shifter may include a word (or another grammatical structure) that alters and/or intensifies a meaning of a sentence and/or of a word. In some instances, the prediction system may generate the sentiment scores per topic, per time period, and per smoothing function.

The prediction system may automate time series analysis in order to identify useful signals toward forecasting time series. For example, the prediction system may use a forecasting model (e.g., a machine learning model) to forecast a time series based on the refined topics (e.g., based on the sentiment scores generated for the sentences of the refined topics). The prediction system may perform back-testing of a performance of the forecasted time series. For example, the prediction system may evaluate the performance of the forecasted time series using a mean absolute percentage error, using an R-squared, among other examples.

When perform the back-testing of the performance of the forecasted time series, the prediction system may determine whether the performance satisfies a performance threshold. If the performance does not satisfy the performance threshold, the prediction system may further refine the refined topics in a manner similar to the manner described above. In this regard, implementations described herein provide a connection between a process for signal discovery and the performance of the time series forecasted based on signals identified by way the signal discovery. Accordingly, topics are discovered based on the text corpus but also based on the performance on a particular time series of a modeling interest. In some instances, different analyzed time series can lead to different discovered signals.

In some situations, the forecasted time series may include data related to operations of computing systems. For example, the prediction system may determine signals that may be used to more accurately forecast time series related to storage resources usage of computing systems, energy consumptions of the computing systems, network resources usage of the computing systems. As an example, if the sentiment scores of the topics vary from positive to negative during a prior period of time, the forecasting model may predict an increase in resources usage/consumption during a subsequent period of time. An advantage of the accuracy of the forecasted time series is improvement of operations of the computing systems. For example, based on the accuracy of the forecasted time series, the computing systems may improve the storage resources usage, the energy consumptions, and the network resources usage.

In some situations, the forecasted time series may include data related to financial applications. For example, the prediction system may determine signals that may be used to more accurately forecast time series related to interest rates, index prices, and/or rates of returns at different maturities. As an example, if the sentiment scores of the topics vary from positive to negative during a prior period of time, the forecasting model may predict an increase in interest rates during a subsequent period of time. An advantage of the accuracy of the forecasted time series is improvement of operations of the computing systems. For example, based on the accuracy of the forecasted time series, the operations of the computing systems may be improved.

Implementations described herein may more accurately predict a performance of a forecasted time series. In this regard, accuracies in forecasting time series and/or in predicting the performance of the forecasted time series may prevent malfunction of computing systems that utilize the forecasted time series. Accordingly, implementations described herein may preserve computing resources, network resources, and other resources that would have otherwise been used to identify inaccuracies in forecasting time series and/or in predicting the performance of the forecasted time series, used to remedy the inaccuracies, and used to re-configure the computing systems.

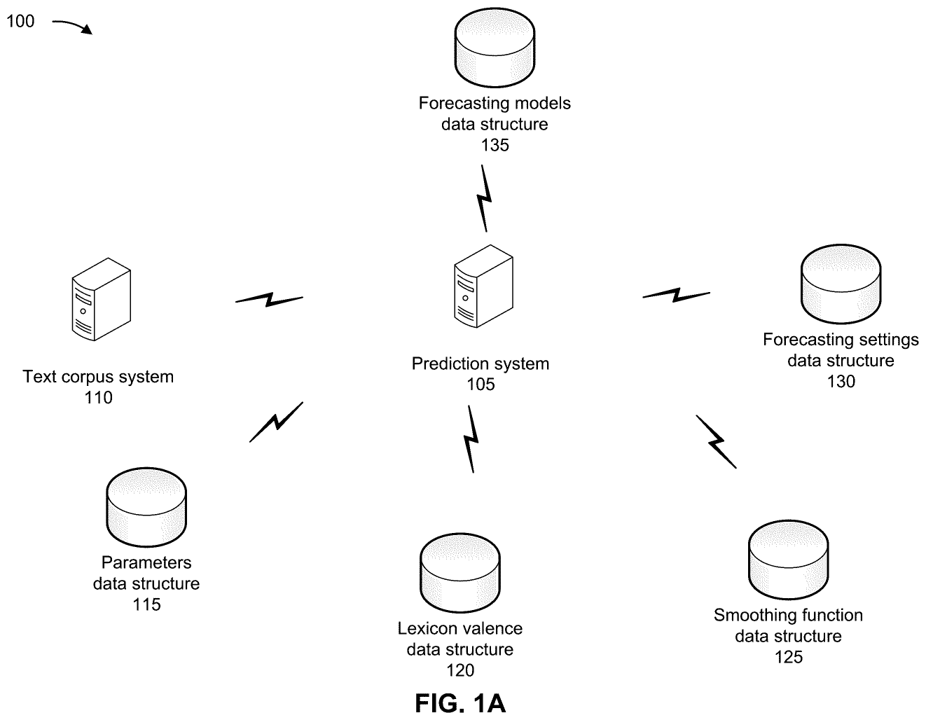

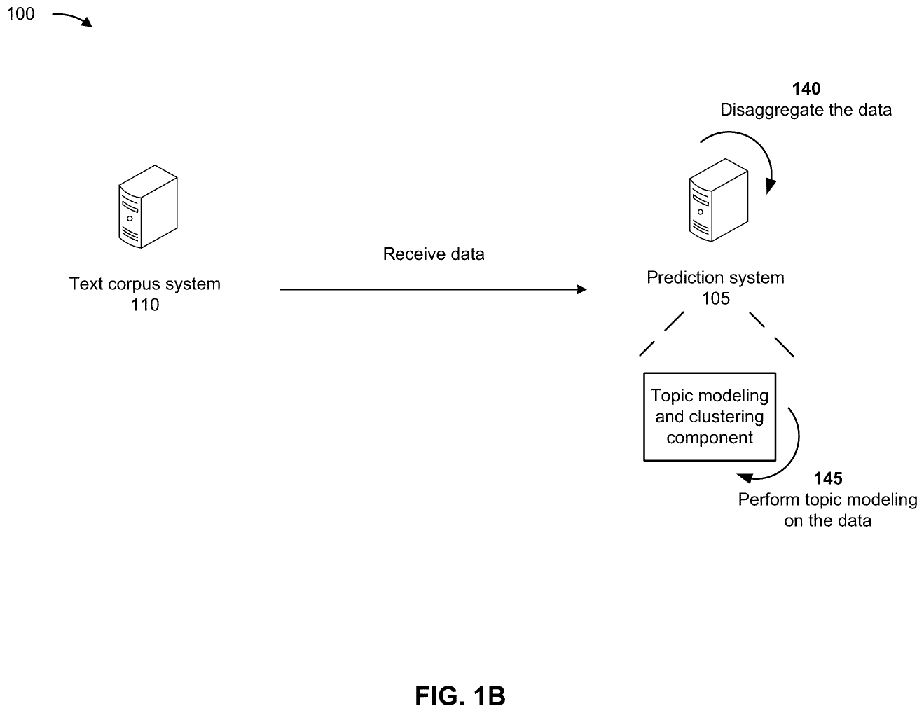

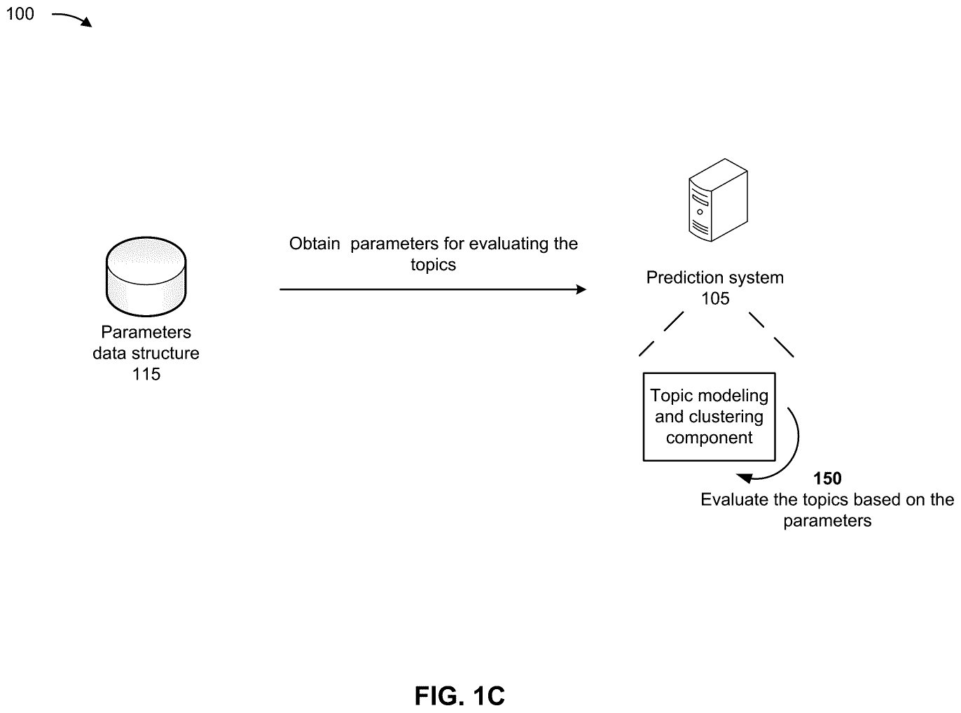

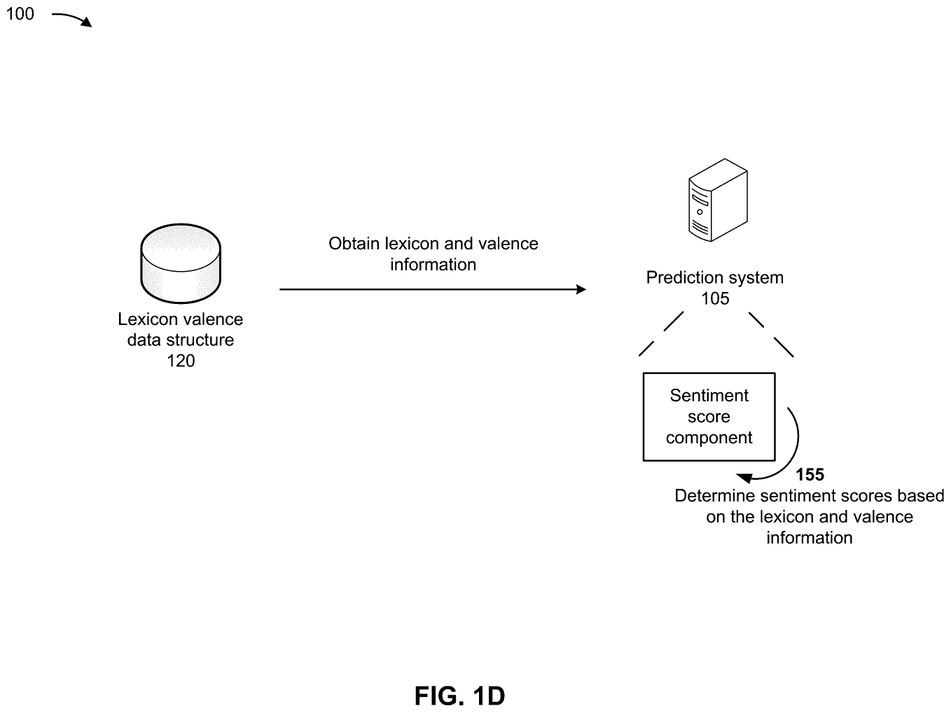

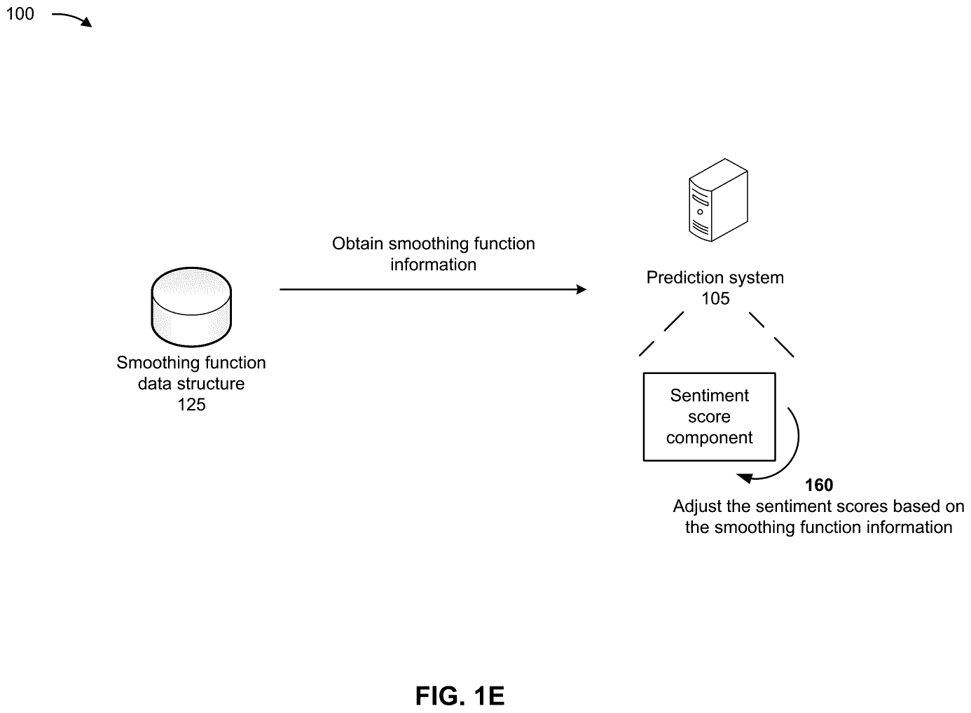

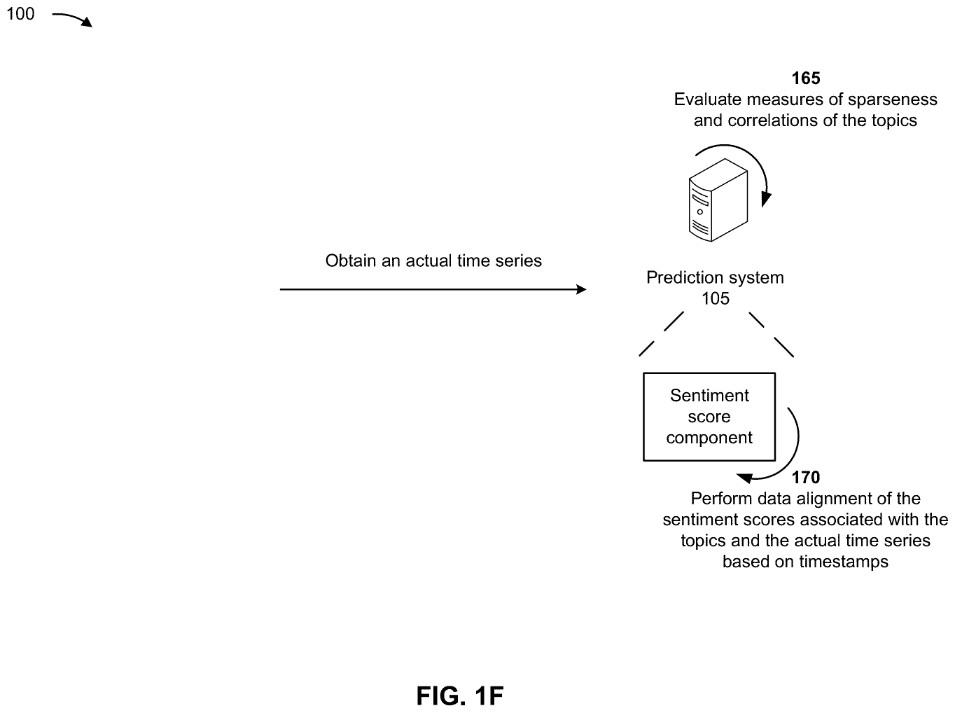

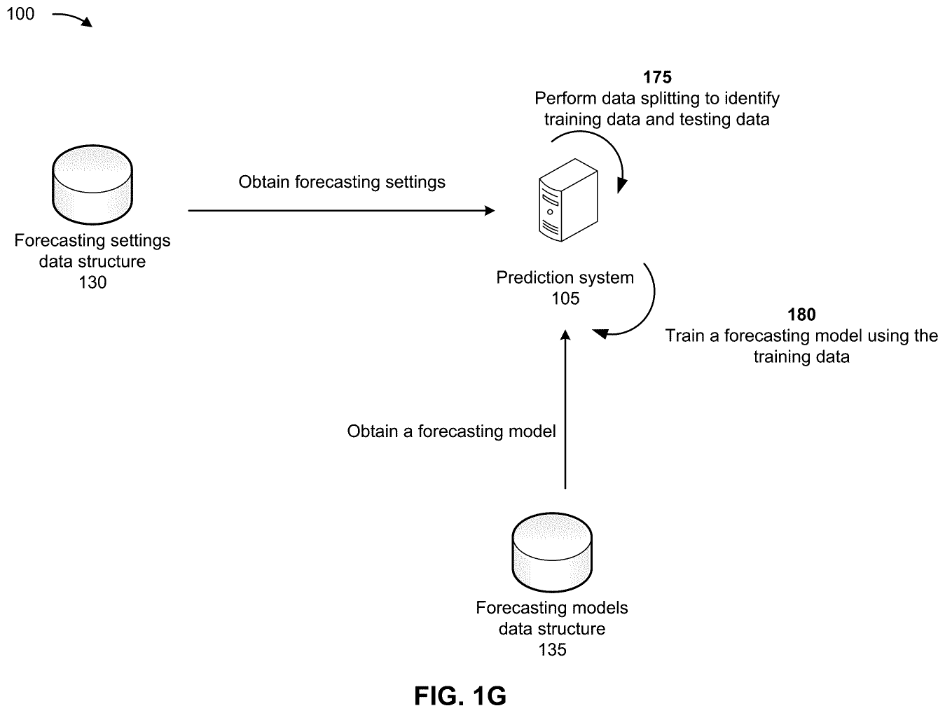

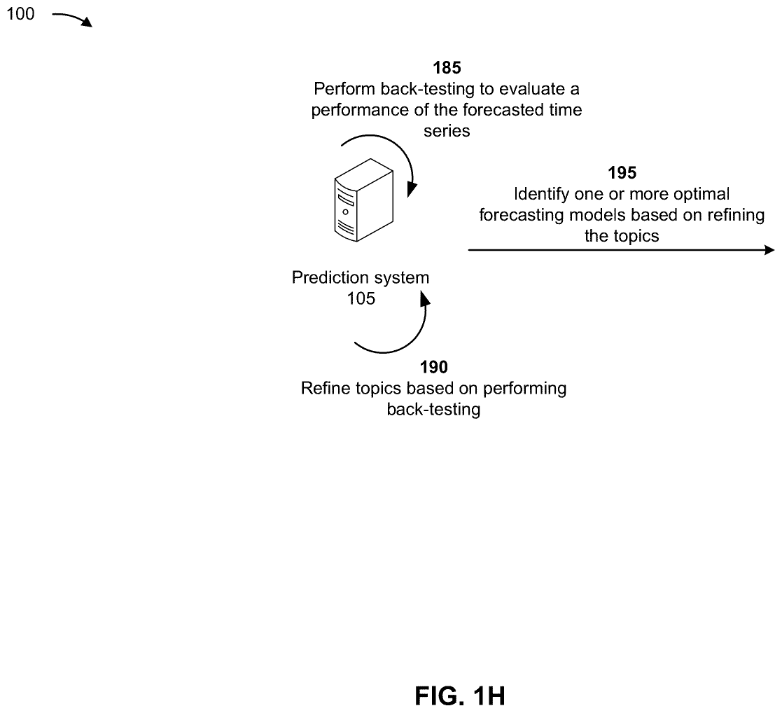

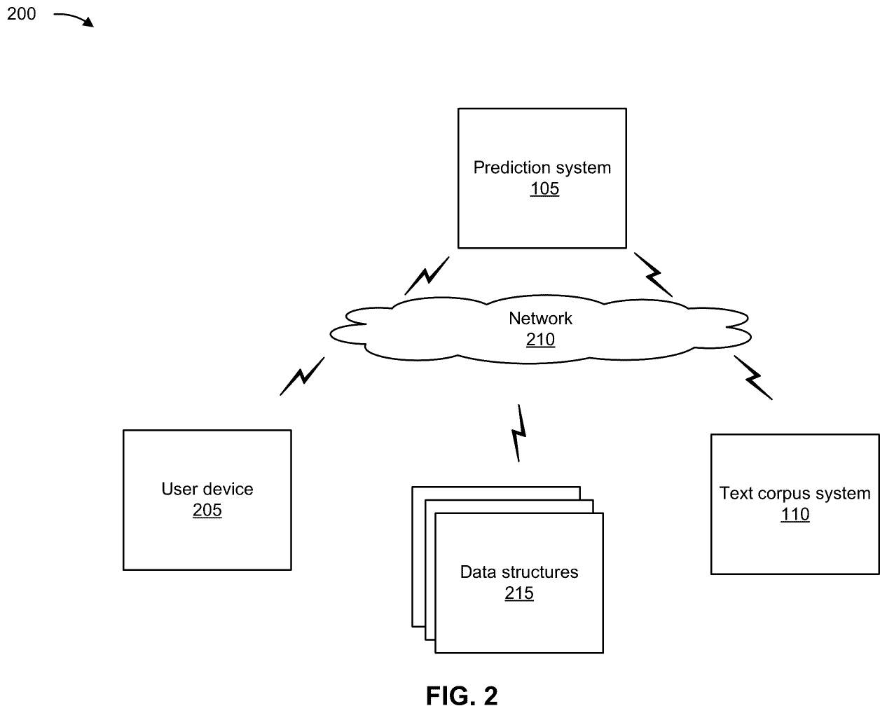

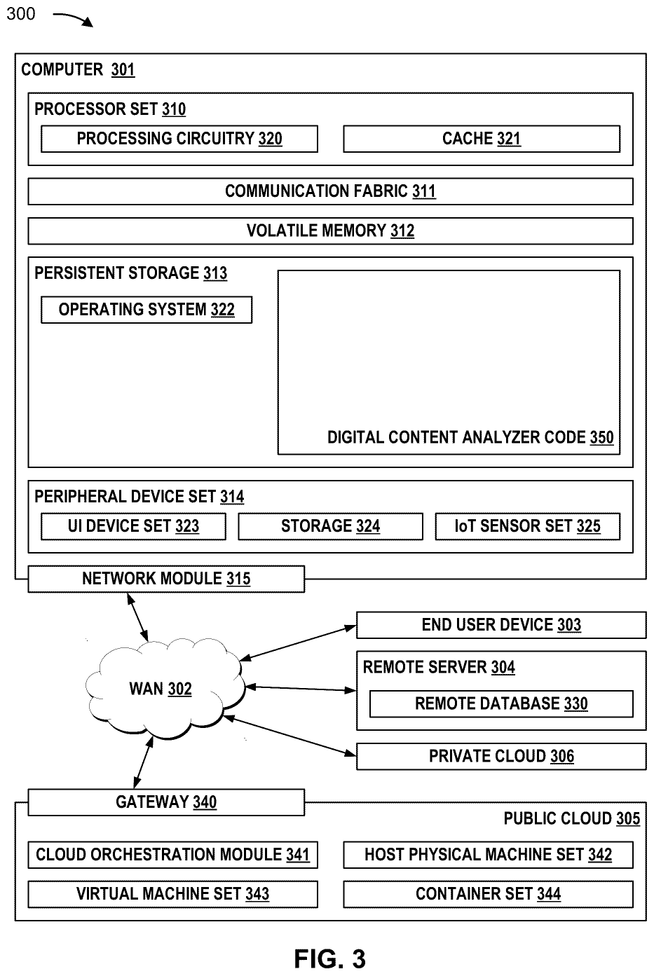

FIGS. 1A-1H are diagrams of an example implementation 100 described herein. As shown in FIGS. 1A-1H, example implementation 100 includes a prediction system 105, a text corpus system 110, a parameters data structure 115, a lexicon valence data structure 120, a smoothing function data structure 125, a forecasting settings data structure 130, and a forecasting models data structure 135. These devices are described in more detail below in connection with FIG. 2 and FIG. 3. In some situations, the above-mentioned data structures may be stored on (or hosted by) one or more devices, such as prediction system 105.

Prediction system 105 may include one or more devices configured to receive, generate, store, process, and/or provide information associated with forecasting time series and/or predicting a performance of forecasted time series, as explained herein. For example, prediction system 105 may be configured to discover signals (e.g., topics) that may be used to forecast time series and/or used to predict a performance of the forecast time series.

As shown in FIGS. 1A-1H, prediction system 105 may include a topic modeling and clustering component and include a sentiment score component. The topic modeling and clustering component may be configured to perform actions related to topic discovery. The sentiment score component may be configured to perform actions related to determining and/or adjusting sentiment scores.

Text corpus system 110 may include one or more devices configured to receive, generate, store, process, and/or provide information associated with forecasting time series and/or predicting a performance of forecasted time series, as explained herein. For example, text corpus system 110 may store data that may be used to identify signals used to forecast time series and/or to predict a performance of the forecasted time series. In some situations, text corpus system 110 may include a web server and the data may include a text corpus of hypertext markup language (HTML) documents.

Parameters data structure 115 may include a database, a table, a queue, and/or a linked list that stores parameters that may be used to discover signals (e.g., topics). For example, parameters data structure 115 may store parameter spaces regarding the signals. For instance, parameters data structure 115 may store information regarding hierarchical topic levels, a maximum number of topics/clusters per hierarchical level, a maximum size of each topic, a minimum size of each topic, and/or words/phrases frequencies/supports per topic, among other examples. As used herein, a size of a topic may refer to a number of sentences being assigned to the topic. The parameters discussed herein may be parameters for controlling the process of generating and choosing topics.

Lexicon valence data structure 120 may include a database, a table, a queue, and/or a linked list that stores a library of lexicons and valence shifters that include a sentiment score for each word and/or each phrase or sentence. Smoothing function data structure 125 may include a database, a table, a queue, and/or a linked list that stores information regarding different smoothing functions. The smoothing functions may include beta distributions, exponential distributions, among other examples.

Forecasting settings data structure 130 may include a database, a table, a queue, and/or a linked list that stores information regarding settings for forecasting time series. The settings may identify forecasting horizons (e.g., 1-month ahead, 6-month ahead, among other examples), skipping periods, testing sizes, among other examples. In some situations, based on the settings, prediction system 105 may split up sentiment scores data and forecast time series into a training set and a testing set, as explained herein.

Forecasting models data structure 135 may include a database, a table, a queue, and/or a linked list that stores information regarding forecasting models. The forecasting models may include models that are trained to forecast (or predict) time series. In some examples, the forecasting models may include one or more statistical models and/or one or more machine learning models. For instance, the forecasting models may include a ridge regression model, a lasso regression model, an elastic net model, a support vector regression model, and/or a deep learning model.

As shown in FIG. 1B, prediction system 105 may receive data from text corpus system 110. For example, prediction system 105 may provide a data request to text corpus system 110 via a network and text corpus system 110 may provide the data to prediction system 105 via the network. In some implementations, the data may include a text corpus that includes one or more documents. In some situations, text corpus system 110 may host one or more web sites. In this regard, prediction system 105 may perform a web crawling operation/a web-scrapping operation to obtain the data from text corpus system 110 (e.g., to obtain HTML documents from text corpus system 110). In some examples, prediction system 105 may perform an HTML parsing and conversion to text on the HTML documents. Additionally, or alternatively, prediction system 105 may perform an HTML element selection and filtering on the HTML documents.

In some situations, prediction system 105 may obtain the data based on receiving a time series request to forecast a time series. The time series request may be received from a user device. In some examples, the time series request may include information identifying a target time series to be forecasted. For example, the information may relate to operations of computing systems. For instance, the information may indicate that the time series is to indicate storage resources usage of the computing systems over a period of time, energy consumptions of the computing systems over a period of time, network resources usage of the computing systems over a period of time, among other examples.

Additionally, or alternatively, the information may relate to financial applications. For instance, the information may indicate that the time series is to indicate interest rates over a period of time, index prices over the period of time, and/or rates of returns at different maturities over the period of time.

In some implementations, prediction system 105 may pre-process the data. For example, prediction system 105 may perform data cleansing operations on the data. For instance, prediction system 105 may remove punctuation, remove whitespaces, and/or collapse newlines. With respect to HTML documents, prediction system 105 may remove uninformative HTML elements, remove tokens, and/or remove web-page markers. Additionally, or alternatively to performing the data cleansing operations, prediction system 105 may perform data normalizing operations on the data. For example, prediction system 105 may normalize multiple formats of the data into a single format (e.g., normalize multiple formats of webpages into one format). Additionally, or alternatively to performing the data normalization operations, prediction system 105 may obtain timestamps of the documents.

As shown in FIG. 1B, and by reference number 140, prediction system 105 may disaggregate the data. For example, after receiving the data, prediction system 105 may determine whether a number of documents included in the data satisfies a number threshold. In some examples, the number threshold may be based on a number of documents that enable a reliable topic clustering.

If prediction system 105 determines that the number of documents does not satisfy the number threshold (e.g., is not large enough for a reliable topic clustering), prediction system 105 may disaggregate the data into paragraphs and/or sentences. For example, prediction system 105 may disaggregate a first document into one or more paragraphs and/or one or more sentences, disaggregate a second document into one or more paragraphs and/or one or more sentences, and so on. As a result, prediction system 105 may obtain a corpus of sentences.

In some situations, when disaggregating the data, prediction system 105 may detect sentence boundaries of sentences included in the data and segment the documents in sentences based on the sentence boundaries. In some examples, prediction system 105 may remove sentences that prediction system 105 determines to be un-informative. Additionally, or alternatively, prediction system 105 may merge sentences from different documents into a single corpus of sentences.

As shown in FIG. 1B, and by reference number 145, prediction system 105 may perform topic modeling on the data. For example, prediction system 105 may perform topic modeling on the text corpus to obtain a set of hierarchical clusters of topics based on default parameters. Information regarding topics, of the set of hierarchical clusters of topics, may be used to determine signals used to forecast time series and/or used to predict performances of forecasted time series. In other words, prediction system 105 may process the data to discover the signals.

Prediction system 105 may perform the topic modeling as an automated discovery of topics from the corpus of documents. In some examples, prediction system 105 may perform the topic modeling using a machine learning model. As an example, prediction system 105 (or the machine learning model) may use a natural language processing (NLP) algorithm for the automated discovery of topics from the corpus of sentences. Prediction system 105 may discover the topics based on the sentences and/or paragraphs obtained by disaggregating the data. For example, based on performing the topic modeling, one or more first sentences may be assigned to a first topic, one or more second sentences may be assigned to a second topic, one or more third sentences may be assigned to a third topic and so on.

Each sentence may be associated with a timestamp. The timestamp may be a timestamp of a document that includes the sentence. In some implementations, the timestamp of the document may a date and/or a time of publication of the document. Accordingly, each topic with its sentiment scores aggregated from its belonged sentences/paragraphs/documents may be associated with at different timestamps.

In some examples, the first topic may be a main topic of a cluster of topics, the second topic and the third topic may be sub-topics of the main topic, a fourth topic and/or a fifth topic may be sub-topics of the second topic, and so on.

As shown in FIG. 1C, prediction system 105 may obtain parameters for evaluating the topics. For example, based on receiving the time series request, prediction system 105 may obtain the parameters from parameters data structure 115. The parameters may identify hierarchical topic levels, a maximum number of topics/clusters per hierarchical level, a minimum size of each topic, a maximum size of each topic, an expected number of topics, and/or words/phrases frequencies/supports per topic, among other examples. Additionally, prediction system 105 may obtain information identifying suggested topics.

As shown in FIG. 1C, and by reference number 150, prediction system 105 may evaluate the topics based on the parameters obtained from parameters data structure 115. For example, after obtaining the parameters, prediction system 105 may evaluate the topics against the parameters. In some implementations, prior to evaluating the topics against the parameters, prediction system 105 may evaluate a measure of quality of the topics. For example, prediction system 105 may evaluate a measure of diversity of the topics. Additionally, or alternatively, prediction system 105 may evaluate a measure of cohesiveness of the topics. In some situations, prediction system 105 may refine the topics to obtain refined topics if the measure of quality of the topics does not satisfy a quality threshold. For example, prediction system 105 may remove one or more topics and/or add one or more topics.

After evaluating the measure of quality of the topics, prediction system 105 may determine whether the topics satisfy the parameters. For example, prediction system 105 may determine whether hierarchical topic levels of the topics match the hierarchical topic levels identified by the parameters, whether a maximum number of topics/clusters per hierarchical level of the topics match a maximum number of topics/clusters per hierarchical level identified by the parameters, whether a size of each of the topics match a minimum size of each topic identified by the parameters, whether a size of each of the topics match a maximum size of each topic identified by the parameters, and/or whether words/phrases frequencies of each of the topics match words/phrases frequencies/supports per topic identified by the parameters, among other examples.

If prediction system 105 determines the topics do not comply with one or more of the parameters, prediction system 105 may refine the topics as explained herein. For example, when refining the topics, prediction system 105 may prune less relevant and minor topics. For instance, prediction system 105 may remove one or more topics that are less relevant and/or that are minor. In some situations, prediction system 105 may add discovered topics to the sentences of the corpus of sentences as features.

As shown in FIG. 1D, prediction system 105 may obtain lexicon and valence information. For example, after evaluating the topics, prediction system 105 may determine that sentiment scores are to be determined for the sentences of the corpus of sentences. In this regard, prediction system 105 may obtain the lexicon and valence information from lexicon valence data structure 120. The lexicon and valence information may identify a library of lexicons and/or of valence shifters. Additionally, the lexicon and valence information may identify sentiment scores for different words and/or sentences. Prediction system 105 may use the lexicon and valence information to determine the sentiment scores.

As shown in FIG. 1D, and by reference number 155, prediction system 105 may determine sentiment scores based on lexicon and valence information. For example, after obtaining the lexicon and valence information, prediction system 105 may determine the sentiment scores for the sentences of the corpus of sentences. In some implementations, prediction system 105 may compute sentiment scores per documents/sentences and per lexicons. For example, for a particular sentence, prediction system 105 may determine a first sentiment score based on a first lexicon and determine a second sentiment score based on a second lexicon. For instance, the first sentiment score and the second sentiment score may be of different magnitude, different signs (e.g., positive score or negative score), among other examples. Each lexicon may include a respective score for each word of a plurality of words. In this regard, each lexicon may determine a score for each word in a sentence and determine a sentiment score based on the score determined for each word in the sentence. In some situations, a score for a particular word in the first lexicon may be different than a score for the particular word in the second lexicon. Accordingly, the first lexicon and the second lexicon may generate different sentiment scores for a same sentence.

In some situations, prediction system 105 may modify a sentiment score based on a valence shifter of a valence lexicon. For example, prediction system 105 may change the sentiment score from a positive score to a negative score (and vice versa) or may change the sentiment score by decreasing or amplifying a magnitude of the sentiment score. For example, including the word “not” in a sentence may modify a positive sentiment score (for the sentence) to a negative sentiment score (for the sentence).

Prediction system 105 may aggregate the sentiment scores from sentences and/or paragraphs and/or documents level into topics level. For example, prediction system 105 may aggregate one or more first sentiment scores of the one or more first sentences assigned to the first topic, aggregate one or more second sentiment scores of the one or more second sentences assigned to the second topic, and so on. In this regard, prediction system 105 may generate sentiment scores per topic.

In some examples, prediction system 105 may generate the sentiment scores per period of time. For example, prediction system 105 may aggregate sentiment scores for sentences assigned to a topic and associated with a first period of time, aggregate sentiment scores for sentences assigned to the topic and associated with a second period of time, and so on. Based on the foregoing, the topics may be associated with different sentiment scores at different timestamps.

As shown in FIG. 1E, prediction system 105 may obtain smoothing function information. For example, after determining the sentiment scores, prediction system 105 may obtain the smoothing function information from smoothing function data structure 125. The smoothing function information may identify smoothing functions that may include beta distributions, exponential distributions, among other examples.

As shown in FIG. 1E, and by reference number 160, prediction system 105 may adjust the sentiment scores based on the smoothing function information. For example, prediction system 105 may adjust the sentiment scores per topic using the smoothing functions (identified by the smoothing function information) over a period of time that is based on a lookback window (e.g., a window of time for looking back). For example, prediction system 105 may adjust a sentiment score using a first smoothing function to obtain a first adjusted sentiment score, may adjust the sentiment score using a second smoothing function to obtain a second adjusted sentiment score, and so on. Additionally, or alternatively, prediction system 105 may adjust the sentiment scores using the smoothing functions over different periods of time. In this regard, prediction system 105 may generate the sentiment scores per smoothing function.

As shown in FIG. 1F, and by reference number 165, prediction system 105 may evaluate measures of sparseness and correlations of topics. For example, prediction system 105 may evaluate the measure of sparseness of the topics over time and/or evaluate the measure of correlation of the topics. For instance, prediction system 105 may determine whether the measure of sparseness satisfies a sparseness threshold.

If the measure of sparseness satisfies the sparseness threshold, the number of topics may be reduced and/or the documents may be further disaggregated into sentences and/or paragraphs. In other words, if the measure of sparseness satisfies the sparseness threshold, prediction system 105 may refine the topics as explained herein. As an example, prediction system 105 may perform a new exploration of parameters data structure 115. For instance, prediction system 105 may perform a grid-search and a random-search or greedy-search throughout different ranges of the parameters of parameters data structure 115 in order to discover different topics.

As shown in FIG. 1F, prediction system 105 may obtain an actual time series. In some situations, the actual time series may be generated based on actual data related to the data obtained from text corpus system 110. For example, if the data obtained from text corpus system 110 is data that is to be used to forecast a time series of interest rates over a period of time, the actual data may be actual interest rates over the period of time.

Alternatively, if the data obtained from text corpus system 110 is data that is to be used to forecast energy consumption of a computing system over a period of time, the actual data may be actual energy consumed by the computing system over the period of time. In this regard, the actual time series may be used to evaluate a performance of a forecasted time series.

As shown in FIG. 1F, and by reference number 170, prediction system 105 may perform data alignment of the sentiment scores associated with the topics and the actual time series based on timestamps. For example, prediction system 105 may align the timestamps associated with the topics and the timestamps associated with the actual time series. In other words, prediction system 105 may align two data modalities based on the timestamps of the two data modalities. Additionally, or alternatively, prediction system 105 may align frequencies associated with the topics and frequencies associated with the actual time series.

As shown in FIG. 1G, prediction system 105 may obtain forecasting settings. For example, prediction system 105 may obtain the forecasting settings from forecasting settings data structure 130. The forecasting settings may include forecasting horizons (e.g., 1-month ahead, 6-month ahead, among other examples), skipping periods, testing sizes, among other examples. The forecasting settings may be used by prediction system 105 to split data into training data and testing data. For example, prediction system 105 may split the data in accordance with the forecasting horizons, the skipping periods, the testing sizes, among other examples.

As shown in FIG. 1G, and by reference number 175, prediction system 105 may perform data splitting to identify training data and testing data. For example, prediction system 105 may split data regarding the sentiment scores and data regarding the time series in the training data and the testing data. The training data may be data that is used to train forecasting models. The training data may include input features for training the forecasting models. In some examples, the input features may include information regarding the topics. The testing data may be data that is used to evaluate a performance of forecasted time series generated by the forecasting models.

Prediction system 105 may split the data in accordance with the forecasting settings. As an example, prediction system 105 may split the data at a chosen split point (e.g., a particular point in time). The split point may be identified based on the forecasting horizons, the skipping periods, the testing sizes. For example, the split point may be 2020Jan. And assuming that the forecasting model is set to analyze the text data (the sentiment scores of the topics) that appeared in the last 6 months (denoted as x below as the input data) to forecast the next 2 months (denoted as y below as the output data) on the time series, then the time period of the last training sample (in the training set) will be x=[2019May-2019Oct], y=[2019Nov-2019Dec], the second last training sample is x=[2019Apr-2019Sep], y=[2019Oct-2019Nov], etc. (e.g., the data samples from 2019Dec backward in time); and the first testing sample (in the test set) x=[2020Jan 2020Jun], y=[2020Jul-2020Aug], the second testing sample is x=[2020Feb 2020Jul], y=[2020Aug-2020Sep], etc. (e.g., the data samples from 2020Jan forward in time).

In other words, prediction system 105 may determine a first period of time that precedes the particular point in time and a second period of time that follows the particular point in time. Prediction system 105 may train forecasting models using a portion of the topics and sentiment scores associated with the first period of time. Additionally, prediction system 105 may evaluate a performance of forecasted time series using a portion of data, of the actual time series, associated with the second period of time.

As shown in FIG. 1G, prediction system 105 may obtain a forecasting model. For example, prediction system 105 may select a forecasting model from the forecasting models stored by forecasting models data structure 135. The forecasting model may be a statistical model. Alternatively, the forecasting model may be a machine learning model.

As shown in FIG. 1G, and by reference number 180, prediction system 105 may train the forecasting model using the training data. For example, after splitting the data to identify the training data, prediction system 105 may train the forecasting model selected from forecasting models data structure 135. For instance, the forecasting model may be trained by analyzing the training data to make a prediction. After being training using the training data, prediction system 105 may be configured to generate a forecasted time series. For example, the forecasting model may predict time series data over the period of time associated with the testing data.

As shown in FIG. 1H, and by reference number 185, prediction system 105 may perform back-testing to evaluate a performance of a forecasted time series. For example, prediction system 105 may perform back-testing to evaluate the performance of the forecasted time series. For example, prediction system 105 may compute the performance of the forecasted time series using a mean absolute percentage error (MAPE), using an R-squared (R2), among other examples.

When performing the back-testing, prediction system 105 may compute the performance based on all testing data (e.g., from 2020Jan forward). Computing the performance in this manner may be referred to as an out-of-sample performance (e.g., because the testing data is not used to train the forecasting model). In some examples, prediction system 105 may compute the performance computed on all the training data (e.g., from 2019Dec backward). Computing the performance in this manner may be referred to as in-sample performance/evaluation. In this regard, once the forecasting model has been trained, prediction system 105 may re-test the forecasting model on the training data. Prediction system 105 may compare the out-of-sample performance and the in-sample performance. Based on the comparison, prediction system 105 may determine whether the forecasting model has been well-trained, been overfitted or underfitted.

In some examples, prediction system 105 may compare forecasted time series data of the forecasted time series and actual time series data of the actual time series. In other words, prediction system 105 may compare forecasted data and actual data (e.g., data that has been measured).

As shown in FIG. 1H, and by reference number 190, prediction system 105 may refine the topics based on performing the back-testing. For example, prediction system 105 may determine whether the forecasting model has been well-trained, been overfitted or underfitted. In other words, prediction system 105 may determine whether the performance of the forecasted time series satisfies a performance threshold.

If the performance of the forecasted time series does not satisfy the performance threshold, prediction system 105 may refine the topics as explained herein. Because the parameters controlling the process of discovering (or generating) topics are stored in parameters data structure 115, prediction system 105 may perform a grid-search, a random-search or greedy-search throughout the ranges of the parameters in order to find an optimal set of topics that leads to a best performance of sentiment scores over a particular time series.

Accordingly, as explained herein, the topics may be revised and tuned automatically based on a performance on the forecasted time series. In this regard, different forecasted time series may lead to different relevant topics being discovered.

After refining the topics, another forecasting model (or the same forecasting model) may be identified and trained using the refined topics. After being trained using the refined topics, the forecasting model may generate another forecasted time series. The forecasting time series may be evaluated as describe herein.

As shown in FIG. 1H, and by reference number 195, prediction system 105 may identify one or more optimal forecasting models based on refining the topics. The process of refining the topics, training a forecasting model, and evaluating a performance of the forecasted time series may performed multiple times until prediction system 105 identifies one or more optimal forecasting models and a set of topics used to train the one or more optimal forecasting models. For example, as a result of performing the above process multiple times, prediction system 105 may generate multiple forecasting models (e.g., one model using 20 generated topics, another model using 10 topics, and so on).

Prediction system 105 may rank the forecasting models based on the performance (using metrics like MAPE, R2) on the testing data (out-of-sample/back-testing). Based on ranking the forecasting models, prediction system 105 may choose the forecasting model having smallest MAPE or highest R2 on the testing data.

In some implementations, when top ranked forecasting models have similar small MAPE and high R2, prediction system 105 may identify the top ranked forecasting models as part of a forecasting system. In such an instance, prediction system 105 may aggregate (e.g., based on averaging) the predicted values of the forecasting system as the forecasted values for time series generated by the forecasting system. Alternatively, the forecasting system may provide all the forecasting values as a distribution of forecasted values, which provides more information such as a measure of uncertainty over the forecasted time series.

The forecasting system may provide explanation information. The explanation information may identify topics that are most important, periods of time associated with the topics, one or more lexicons, valence shifters and/or one or more smoothing functions used to generate sentiment scores, among other examples. Prediction system 105 may provide forecasting system information regarding the one or more optimal forecasting models to a user device. The forecasting system information may identify the one or more optimal forecasting models, a measure of uncertainty over the forecasted time series (e.g., uncertainty scores of the forecasted time series data), and/or the explanation information.

Implementations described herein may more accurately forecast a time series and/or predict a performance of a forecasted time series. Topics, identified by prediction system 105, may be being revised and tuned automatically based on performance on forecasted time series. In this regard, prediction system 105 may identify relevant (fine-tuned) predictive topics (along with valid periods of time associated with the topics). As a result of refining the topics, prediction system 105 may identify one or more optimal forecasting models as a forecasting system.

An advantage of the accuracy of the forecasted time series is improvement of operations of computing systems that utilize the forecasted time series. For example, based on the accuracy of the forecasted time series, the computing systems may improve the storage resources usage, the energy consumptions, and the network resources usage. Additionally, accuracies in forecasting time series and/or in predicting the performance of the forecasted time series may prevent malfunction of the computing systems that utilize the forecasted time series. Accordingly, implementations described herein may preserve computing resources, network resources, and other resources that would have otherwise been used to identify inaccuracies in forecasting time series and/or in predicting the performance of the forecasted time series, to remedy the inaccuracies, and to re-configure the computing systems.

As indicated above, FIGS. 1A-1H are provided as an example. Other examples may differ from what is described with regard to FIGS. 1A-1H. The number and arrangement of devices shown in FIGS. 1A-1H are provided as an example. A network, formed by the devices shown in FIGS. 1A-1H may be part of a network that comprises various configurations and uses various protocols including local Ethernet networks, private networks using communication protocols proprietary to one or more companies, cellular and wireless networks (e.g., Wi-Fi), instant messaging, HTTP and simple mail transfer protocol (SMTP, and various combinations of the foregoing.

There may be additional devices (e.g., a large number of devices), fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

FIG. 2 is a diagram of an example environment 200 in which systems and/or methods described herein can be implemented. As shown in FIG. 2, environment 200 may include prediction system 105, text corpus system 110, user device 205, and one or more data structures 215. The one or more data structures 215 may correspond to the data structures discussed in connection with FIGS. 1A-1H. Prediction system 105, text corpus system 110, and the one or more data structures 215 have been described above in connection with FIG. 1. Devices of environment 200 can interconnect via wired connections, wireless connections, or a combination of wired and wireless connections.

Prediction system 105 may include a communication device and a computing device. For example, prediction system 105 includes computing hardware used in a cloud computing environment. In some examples, prediction system 105 may include a server, such as an application server, a client server, a web server, a database server, a host server, a proxy server, a virtual server (e.g., executing on computing hardware), or a server in a cloud computing system.

Text corpus system 110 may include a communication device and a computing device. For example, text corpus system 110 includes computing hardware used in a cloud computing environment. In some examples, text corpus system 110 may include a server, such as an application server, a client server, a web server, a database server, a host server, a proxy server, a virtual server (e.g., executing on computing hardware), or a server in a cloud computing system.

User device 205 may include one or more devices capable of receiving, generating, storing, processing, and/or providing information associated with associated with forecasting time series and/or predicting a performance of forecasted time series, as described elsewhere herein. In some examples, user device 205 may receive the forecasting system information from prediction system 105. User device 205 may include a communication device and a computing device. For example, user device 205 may include a wireless communication device, a mobile phone, a user equipment, a laptop computer, a tablet computer, a desktop computer, or a similar type of device.

Network 210 includes one or more wired and/or wireless networks. For example, network 210 may include Ethernet switches. Additionally, or alternatively, network 210 may include a cellular network, a public land mobile network (PLMN), a local area network (LAN), a wide area network (WAN), a private network, the Internet, and/or a combination of these or other types of networks. Network 210 enables communication between prediction system 105, text corpus system 110, user device 205, and the one or more data structures 215.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as new digital content analyzer code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 1. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

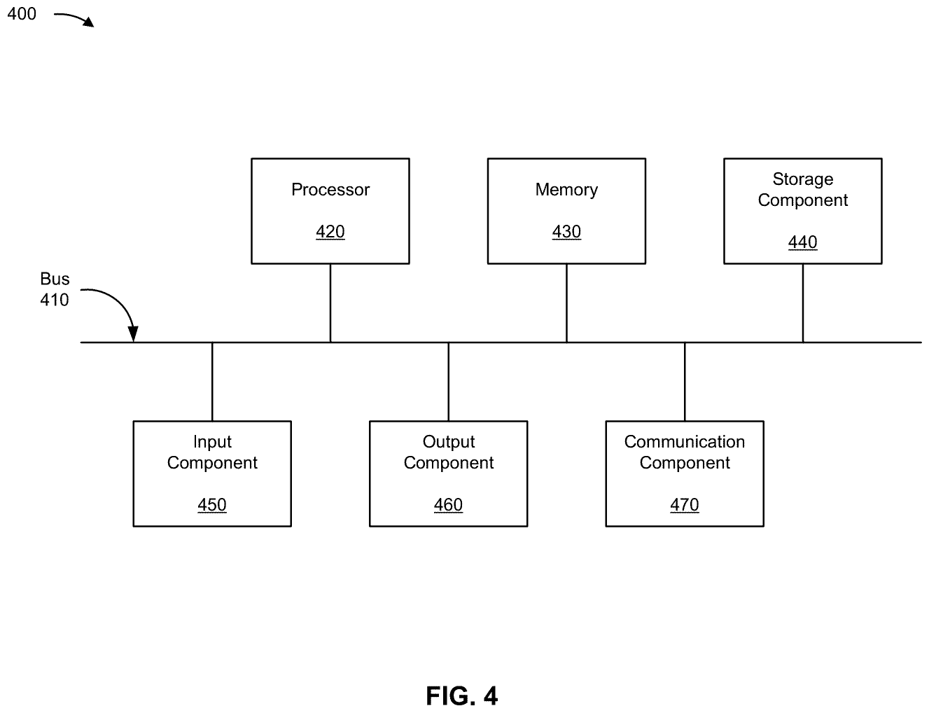

FIG. 4 is a diagram of example components of a device 400, which may correspond to prediction system 105, text corpus system 110, and/or user device 205. In some implementations, prediction system 105, text corpus system 110, and/or user device 205 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

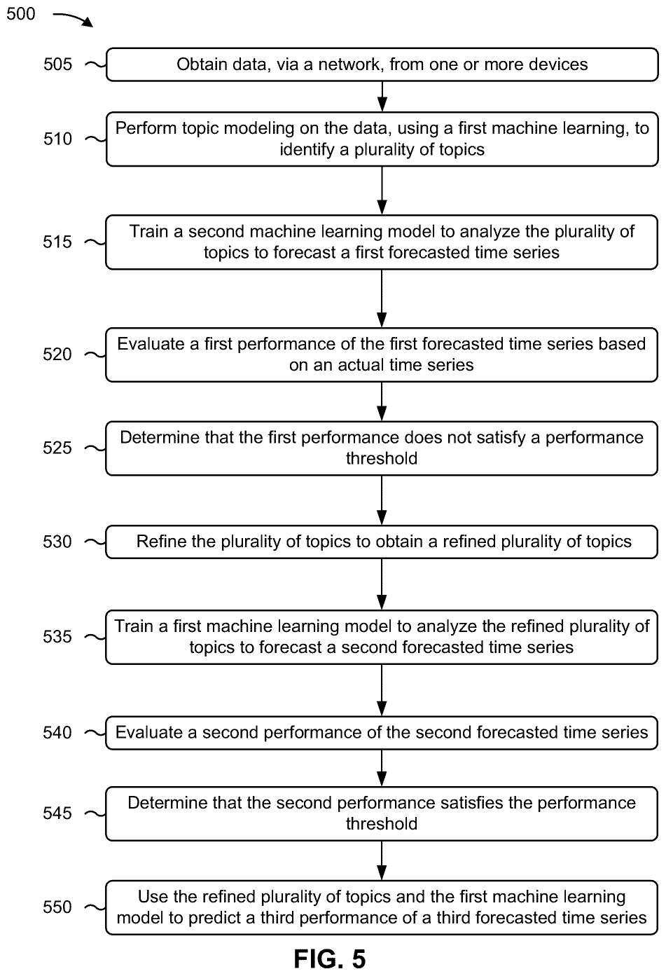

FIG. 5 is a flowchart of an example process 500 related to forecasting time series and/or predicting a performance of forecasted time series. In some implementations, one or more process blocks of FIG. 5 may be performed by a prediction system (e.g., prediction system 105). In some implementations, one or more process blocks of FIG. 5 may be performed by another device or a group of devices separate from or including the prediction system, such as a text corpus system (e.g., text corpus system 110) and/or a user device (e.g., user device 205). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining data, via a network, from one or more devices (block 505). For example, the prediction system may obtain data, via a network, from one or more devices, as described above.

As further shown in FIG. 5, process 500 may include processing the data, using a first machine learning, to identify a plurality of signals (block 510). For example, the prediction system may process the data, using a first machine learning, to identify a plurality of signals, as described above. The plurality of signals may include a plurality of topics. In this regard, the prediction system may perform topic modeling on the data to obtain the plurality of topics (e.g., to obtain a set of hierarchical clusters of topics), as explained herein. For example, the prediction system may perform the topic modeling as an automated discovery of topics from the data (e.g., a text corpus or a corpus of documents).

As further shown in FIG. 5, process 500 may include training a second machine learning model to analyze the plurality of signals to forecast a first forecasted time series (block 515). For example, the prediction system may train a second machine learning model to analyze the plurality of signals to forecast a first forecasted time series, as described above. The second machine learning model is trained using information regarding the plurality of signals. In some implementations, the second machine learning model is trained using information regarding the plurality of signals.

As further shown in FIG. 5, process 500 may include evaluating a first performance of the first forecasted time series based on an actual time series generated based on time series data related to the data from the one or more devices (block 520). For example, the prediction system may evaluate a first performance of the first forecasted time series based on an actual time series generated based on time series data related to the data from the one or more devices, as described above.

As further shown in FIG. 5, process 500 may include determining that the first performance does not satisfy a performance threshold (block 525). For example, the prediction system may determine that the first performance does not satisfy a performance threshold, as described above.

As further shown in FIG. 5, process 500 may include the plurality of signals to obtain a refined plurality of signals (block 530). For example, the prediction system may the plurality of signals to obtain a refined plurality of signals, as described above. The plurality of signals are refined based on determining that the first performance does not satisfy the performance threshold. In some implementations, the plurality of signals are refined based on determining that the first performance does not satisfy the performance threshold.

As further shown in FIG. 5, process 500 may include training a third machine learning model to analyze the refined plurality of signals to forecast a second forecasted time series (block 535). For example, the prediction system may train a third machine learning model to analyze the refined plurality of signals to forecast a second forecasted time series, as described above. The third machine learning model is trained using information regarding the refined plurality of signals. In some implementations, the third machine learning model is trained using information regarding the refined plurality of signals.

As further shown in FIG. 5, process 500 may include evaluating a second performance of the second forecasted time series (block 540). For example, the prediction system may evaluate a second performance of the second forecasted time series, as described above.

As further shown in FIG. 5, process 500 may include determining that the second performance satisfies the performance threshold (block 545). For example, the prediction system may determine that the second performance satisfies the performance threshold, as described above.

As further shown in FIG. 5, process 500 may include using the refined plurality of signals and the third machine learning model to predict a third performance of a third forecasted time series forecasted by the third machine learning model based on determining that the second performance satisfies the performance threshold (block 550). For example, the prediction system may use the refined plurality of signals and the third machine learning model to predict a third performance of a third forecasted time series forecasted by the third machine learning model based on determining that the second performance satisfies the performance threshold, as described above. In some examples, the prediction system may use the refined plurality of signals and the third machine learning model to predict the third forecasted time series based on determining that the second performance satisfies the performance threshold.

In some implementations, the data is a text corpus. Evaluating a performance of the first time series comprises back-testing the first forecasted time series based on the actual time series.

In some implementations, back-testing the first forecasted time series comprises comparing the first forecasted time series and the actual time series. Determining that the first performance does not satisfy the performance threshold comprises determining a difference, between the first forecasted time series and the actual time series, satisfies a difference threshold.

In some implementations, the data includes a text corpus. Processing the data to identify the plurality of signals comprises determining whether a number of documents, of the text corpus, satisfies a number threshold, disaggregating the text corpus into a plurality of sentences, and identifying a plurality of topics based on the plurality of sentences. One or more sentences, of the plurality of sentences, are associated with a topic of the plurality of topics.

In some implementations, process 500 includes determining one or more sentiment scores for the one or more sentences, aggregating the one or more sentiment scores for the topic to obtain an aggregated sentiment score. Training the second machine learning model comprises training the second machine learning model using the aggregated sentiment score.

In some implementations, determining the one or more sentiment scores comprises automating generating sentiment scores per topic, per time period, and per smoothing function.

In some implementations, the plurality of topics comprises removing one or more topics, from the plurality of topics, based on determining that the first performance does not satisfy the performance threshold

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
forecasting a first forecasted time series using a first machine learning model,
wherein the first machine learning model forecasts the first forecasted time series using a plurality of signals;
refining the plurality of signals to obtain a refined plurality of signals based on evaluating a first performance of the first forecasted time series,
wherein the plurality of signals are refined based on determining that the first performance does not satisfy a performance threshold;
forecasting a second forecasted time series using a second machine learning model,
wherein the second machine learning model forecasts the second forecasted time series using the refined plurality of signals;
determining that a second performance, of the second forecasted time series, satisfies the performance threshold; and
using the refined plurality of signals and the second machine learning model to predict a third forecasted time series based on determining that the second performance satisfies the performance threshold.

2. The computer-implemented method of claim 1, further comprising:
evaluating the first performance of the first forecasted time series,
wherein evaluating the first performance of the first forecasted time series comprises:
back-testing the first forecasted time series based on the actual time series.

3. The computer-implemented method of claim 2, further comprising:
processing data to identify the plurality of signals,
wherein back-testing the first forecasted time series comprises:
comparing the first forecasted time series and an actual time series generated based on time series data related to the data, and
wherein determining that the first performance does not satisfy the performance threshold comprises:
determining a difference, between the first forecasted time series and the actual time series, satisfies a difference threshold.

4. The computer-implemented method of claim 1, further comprising:
processing data to identify the plurality of signals,
where the data includes a text corpus, and
wherein processing the data to identify the plurality of signals comprises:
determining whether a number of documents, of the text corpus, satisfies a number threshold;
disaggregating the text corpus into a plurality of sentences; and
identifying a plurality of topics based on the plurality of sentences,
wherein one or more sentences, of the plurality of sentences, are associated with a topic of the plurality of topics.

5. The computer-implemented method of claim 4, further comprising:
determining one or more sentiment scores for the one or more sentences;
aggregating the one or more sentiment scores for the topic to obtain an aggregated sentiment score; and
training the first machine learning model using the aggregated sentiment score.

6. The computer-implemented method of claim 5, wherein determining the one or more sentiment scores comprises:
automating generating sentiment scores per topic, per time period, and per smoothing function.

7. The computer-implemented method of claim 4, wherein refining the plurality of signals comprises:
removing one or more topics, from the plurality of topics, based on determining that the first performance does not satisfy the performance threshold.

8. A computer program product comprising:
one or more computer readable storage media, and program instructions collectively stored on the one or more computer readable storage media, the program instructions comprising:
program instructions to forecast a first forecasted time series using a first forecasting model,
wherein the first forecasting model is trained using first sentiment scores associated with a plurality of topics;
program instructions to determine that a first performance, of the first forecasted time series, does not satisfy a performance threshold;
program instructions to refine the plurality of topics to obtain a refined plurality of topics,
wherein the plurality of topics are refined based on determining that the first performance does not satisfy the performance threshold;
program instructions to forecast a second forecasted time series using a second forecasting model,
wherein the second forecasting model is trained using second sentiment scores associated with the refined plurality of topics; and
program instructions to use the refined plurality of topics and the second forecasting model to forecast a third forecasted time series based on a second performance of the second forecasted time series satisfying the performance threshold.

9. The computer program product of claim 8, wherein the plurality of topics are associated with a first period of time, and
wherein the first forecasted time series is associated with a second period of time that follows the first period of time.

10. The computer program product of claim 8, wherein the program instructions further comprise:
program instructions to receive information identifying a type of time series data,
wherein the first forecasted time series is generated based on the type of time series data.

11. The computer program product of claim 8, wherein the program instructions further comprise:
program instructions to analyze data to obtain the plurality of topics;
program instructions to determine first timestamps associated with the first sentiment scores;
program instructions to align the first timestamps and second timestamps associated with an actual time series generated based on actual time series data related to the data;
program instructions to determine a particular point in time after aligning the first timestamps and the second timestamps; and
program instructions to evaluate the first performance of the first forecasted time series based on the particular point.

12. The computer program product of claim 11, wherein the program instructions further comprise:
program instructions to determine a first period of time that precedes the particular point in time and a second period of time that follows the particular point in time;
program instructions to train the first forecasting model using a portion of the topics and the sentiment scores associated with the first period of time; and
program instructions to evaluate the first performance of the first forecasted time series using a portion of the actual time series data associated with the second period of time.

13. The computer program product of claim 11, wherein the data is a text corpus,
wherein the text corpus is obtained from a first source, and
wherein the time series data is obtained from a second source.

14. The computer program product of claim 8, wherein the program instructions further comprise:
program instructions to determine whether a number of documents, of a text corpus, satisfies a number threshold;
program instructions to disaggregate the text corpus into a plurality of sentences; and
program instructions to identify the plurality of topics based on the plurality of sentences,
wherein one or more sentences, of the plurality of sentences, are associated with a topic of the plurality of topics.

15. A system comprising:
one or more devices configured to:
forecast a first forecasted time series using a first forecasting model,
wherein the first forecasting model is trained using first sentiment scores associated with a plurality of topics;
determine that a first performance, of the first forecasted time series, does not satisfy a performance threshold;
refine the plurality of topics to obtain a refined plurality of topics,
wherein the plurality of topics are refined based on determining that the first performance does not satisfy the performance threshold;
forecast a second forecasted time series using a second forecasting model,
wherein the second forecasting model is trained using second sentiment scores associated with the refined plurality of topics;
determine that a second performance of the second forecasted time series satisfies the performance threshold; and
use the refined plurality of topics and the second forecasting model to forecast a third forecasted time series based on determining that the second performance satisfies the performance threshold.

16. The system of claim 15, wherein the one or more devices are further configured to:
analyze a text corpus to identify a plurality of topics;
compare the first forecasted time series and an actual time series generated based on time series data related to the text corpus, and
wherein, to determine that the first performance does not satisfy the performance threshold, the one or more devices are configured to:
determining a difference, between the first forecasted time series and the actual time series, satisfies a difference threshold.

17. The system of claim 15, wherein the one or more devices are configured to:
determine one or more sentiment scores for one or more sentences associated with a topic of the plurality of topics;
aggregate the one or more sentiment scores for the topic to obtain an aggregated sentiment score; and
train the first forecasting model using the aggregated sentiment score.

18. The system of claim 15, wherein the one or more devices are configured to:
analyze a text corpus to identify a plurality of topics;
determine first timestamps associated with the first sentiment scores;
align the first timestamps and second timestamps associated with an actual time series generated based on actual time series data related to the text corpus;
determine a particular point in time after aligning the first timestamps and the second timestamps; and
evaluate the first performance of the first forecasted time series based on the particular point.

19. The system of claim 18, wherein the one or more devices are further configured to:
determine a first period of time that precedes the particular point in time and a second period of time that follows the particular point in time;
train the first forecasting model using a portion of the first sentiment scores associated with the first period of time; and
evaluate the first performance of the first forecasted time series using a portion of the actual time series data associated with the second period of time.

20. The system of claim 15, wherein, to refine the plurality of topics, the one or more devices are further configured to:
remove one or more topics, from the plurality of topics, based on determining that the first performance does not satisfy the performance threshold.
